(19) United States
(12) Patent Application Publication
(10) Pub. No.: US 2001/0044796 A1
(43) Pub. Date: Nov. 22, 2001

(54) Totalization system and recording medium

(76) Inventor: Hiroyasu Fujiwara, Kawasaki (JP)

Correspondence Address: STAAS & HALSEY LLP, 700 11TH STREET, NW, SUITE 500, WASHINGTON, DC, 20001, US

(21) Appl. No.: 09/788,391

(22) Filed: Feb. 21, 2001

(30) Foreign Application Priority Data
May 19, 2000 (JP) 2000-148956

(51) Int. Cl. G06F 17/00

(52) U.S. Cl. 707/100; 235/376; 700/17; 700/28; 700/108; 345/764

(57) ABSTRACT

A totalization system for totalizing information to be totalized comprises a to-be-totalized information storage unit, a hierarchical information storage unit, and a computing unit. The to-be-totalized information storage unit (data division) stores information to be totalized. The hierarchical information storage unit (structure) stores hierarchical information used in totalizing the information to be totalized. The computing unit totalizes the information stored in the to-be-totalized information storage unit with a hierarchical structure according to the hierarchical information stored in the hierarchical information storage unit. Creating each of the information to be totalized and the hierarchical information separately eliminates the need to add classification information to the data division.

### BACKGROUND OF THE INVENTION

1. Field of the Invention

The present invention relates to a display system which makes displays on the basis of detail data and structures, and a recording medium.

1. Description of the Related Art

In plants, information collected and added by categories on the basis of production planning are displayed on screens. For example, the week's or month's totals are displayed in tabular form on the basis of production planned numbers by days or the totals by goods are displayed in tabular form on the basis of production planned numbers by goods. Conventionally, classification information required for totalization is added to data divisions which are information to be totalized, and each classified total is computed in a corresponding totalization logic and then displayed.

However, the order of display of detail information or the units of totalization vary greatly from user to user. In this case, since there exists a plurality of items of information to be totalized to which a user wants to refer, it is required to switch the units of totalization from one to another instantly. To this end, it becomes necessary to develop programs corresponding in number to the units of totalization, which requires a too large amount of work to implement.

Since classification information required for totalization work is required to be added to data divisions, addition of items of totalization requires addition of items of classification to all data divisions. Also, it is impossible to add new totalization keys instantly.

### SUMMARY OF THE INVENTION

It is therefore an object of the present invention eliminate the need to add classification information required for totalization work to information to be totalized and allow units of totalization to be switched flexibly.

According to an aspect of the present invention, A totalization system for totalizing information to be totalized comprises a to-be-totalized information storage unit, a hierarchical information storage unit, and a computing unit. The to-be-totalized information storage unit (data division) stores information to be totalized. The hierarchical information storage unit (structure) stores hierarchical information used in totalizing the information to be totalized. The computing unit totalizes the information stored in the to-be-totalized information storage unit with a hierarchical structure according to the hierarchical information stored in the hierarchical information storage unit. Creating each of the information to be totalized and the hierarchical information separately eliminates the need to add classification information to the data division.

In addition, the totalization system may be configured such that the hierarchical information storage unit stores hierarchical information about a plurality of groups, and the computing unit totalizes information stored in the to-be-totalized information storage unit on the basis of hierarchical information about any one of the groups.

This configuration eliminates the need to create as many programs as there are units of totalization in order to totalize information while changing the units of totalization.

### BRIEF DESCRIPTION OF THE DRAWINGS

The features and advantages of the present invention will be more clearly appreciated from the following description taken in conjunction with the accompanying drawings in which like elements are denoted by like reference numerals and in which:

FIG. 1 is a schematic representation of a totalization system according to an embodiment of the present invention;

FIG. 2 shows an example of the structure of FIG. 1;

FIG. 3 is a flowchart for the overall process of the totalization system of FIG. 1;

FIG. 4 is a flowchart for the process of totalizing detail data and displaying the result;

FIG. 5 is a flowchart illustrating the process of displaying detail data on the basis of level specification by user;

FIG. 6 is a flowchart illustrating the process of displaying the results of totalization based on level specification by user;

FIG. 7 shows a computing table according to the present invention;

FIGS. 8 through 11 show examples of on-screen display images according to the present invention;

FIG. 12 is a schematic representation of an information processing unit; and

FIG. 13 is a diagram for use in explanation of recording media transmit signals and transmission media which supply programs and data to the information processing unit.

### DESCRIPTION OF THE PREFERRED EMBODIMENTS

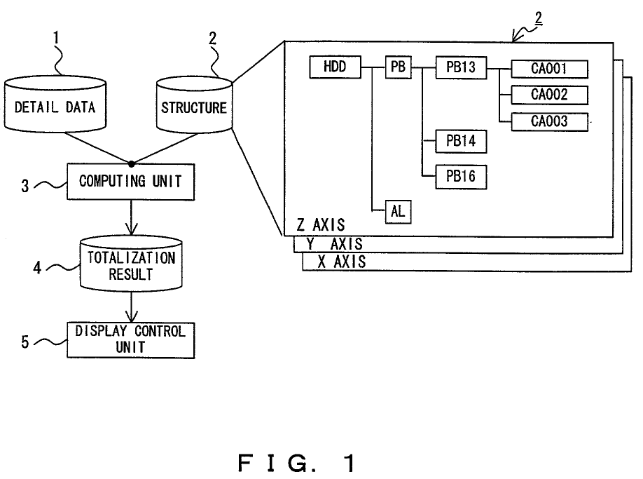

An embodiment of the present invention and its operation will be described in detail below with reference to FIGS. 1 through 11.

FIG. 1 shows the configuration of a totalization system embodying the present invention.

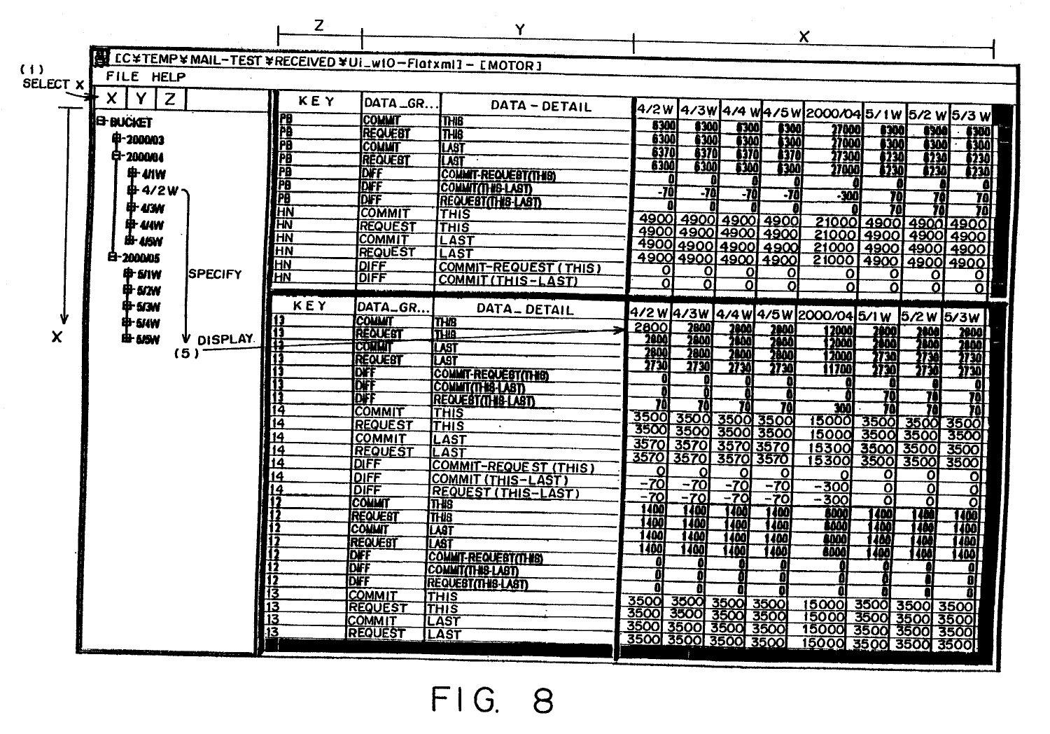

In FIG. 1, detail data 1 is that to be totalized. As an example, detail data are assumed to be data concerning production planned numbers by days, data concerning production planned numbers by goods, etc. (see FIGS. 8 to 13)

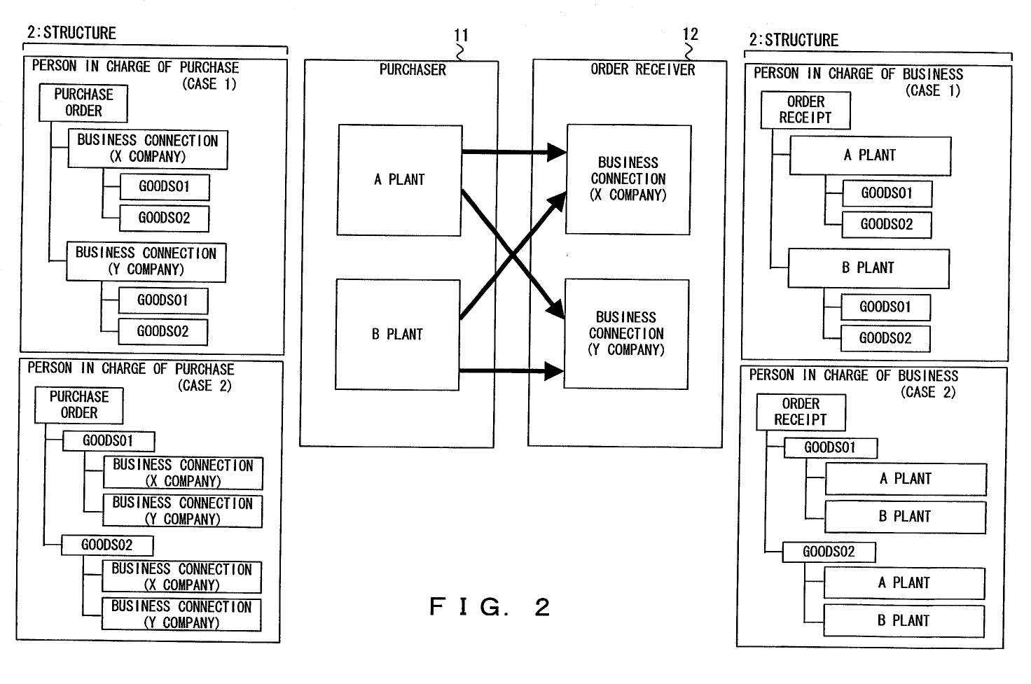

A structure 2 is hierarchical information used in totalizing the detail data 1 hierarchically. For example, the detail data is classified into X-, Y- and Z-axis groups and each group is represented by a hierarchical structure (see FIG. 2 and FIGS. 8 to 11).

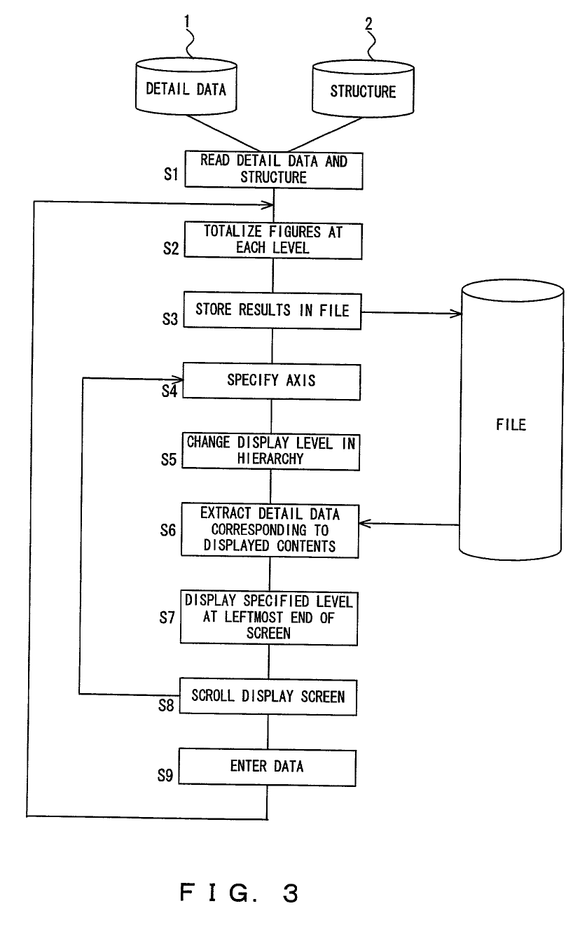

A computing unit 3 is adapted to, on the basis of a level specified on the structure 2, totalize detail data at that level and produce the totalization result 4 (which will be described later with reference to FIGS. 3 to 11).

The totalization result 4 is the result of totalization of detail data.

A display control unit 5 performs display control so as to display the structure 2 and the totalization result 4 on a display screen (which will be described with reference to FIGS. 2 to 11).

In this case, the display control unit 5 may perform display control so that, in addition to the structure 2 and the totalization result 4 at a level specified on the structure 2, the totalization result or data at a lower level than the specified level is displayed as required.

In addition, the display control unit 5 may perform display control so that the totalization result or data at an even lower level of a level specified on the structure 2 and of the lower than the specified level is displayed.

The detail data 1 maybe classified into a plurality of groups, e.g., X, Y and Z groups, with structures 2 each having a hierarchical structure.

Thus, by separately creating detail data 1 and structures 2 and displaying the totalization results at a level specified on the structures 2, at a lower level, and, if necessary, at an even lower level at one time, it becomes possible to eliminate the need to add classification information to data divisions (detail data 1) as in the prior art and to switch the levels instantly so as to display necessary totalization results.

FIG. 2 shows an example of a structure in the totalization system according to the preferred embodiment.

In FIG. 2, the structure 2 is one for each user and has the following hierarchical structure:

person in charge of purchase (case 1): purchase order—business connection—goods

person in charge of purchase (case 2): purchase order—goods—business connection

person in charge of business (case 1): receipt of order—plant—goods

person in charge of business (case 2): receipt of order—goods—plant

For example, a person in charge of purchase (case 1) is an example of a structure having a hierarchical structure of purchase order—business connection—goods. A person in charge of purchase (case 2) is an example of a structure having a hierarchical structure of purchase order—goods—business connection. Each structure is made to have a hierarchical structure which is conveniently easy to use to meet user's requirements. Likewise, in the case of business as well, each structure is made to have a hierarchical structure easy to use.

Purchasers 11, which order goods, are A and B plants here. For persons in charge of purchase work, such structures for person in charge of purchase as have hierarchical structures as described above and shown in FIG. 2 are easy to use.

Order receivers 12, which receive orders for goods from purchasers, are business connections X and Y here. For persons in charge of business who receive orders for goods, such structures for a person in charge of business as have hierarchical structures as described above and shown in FIG. 2 are easy to use.

As described above, the structures 2 are individually created each of which is easy for a respective one of users (persons in charge of purchase and persons in charge of business) to use. This eliminates the need to add classification information to data divisions (detail data 1). As will be described later, when a user specifies a level on the corresponding structure 2, the display control unit 5 allows the totalization results at the level specified on the structure 2 and at a lower level or levels to be automatically displayed.

FIG. 3 is a flowchart illustrating the overall operation of the totalization system.

In step S1, the computing unit 3 reads in the detail data 1 and the structure 2 corresponding to a user are read in.

In step S2, the computing unit 3 totalizes figures in the detail data 1 at each hierarchical level according to the structure 2. In step S3, the computing unit 3 stores the totals at the levels in the structure 2 in a file.

In step S4, the user specifies an axis (any of X, Y and Z axes) to be displayed in the structure 2 read in step S1 (refer to FIGS. 8 to 11 described later). In step S5, the computing unit 3 changes the hierarchy level to be displayed in the hierarchical structure on the basis of the axis specified in step S4 accroding to an instruction by the user (the user specifies the level to be displayed).

In step S6, the display control unit 5 extracts detail data corresponding to the displayed contents in the hierarchy (or the totalization results) from the contents of the file computed in step S3. For example, the display control unit 5 extracts the totalization results or detail data at the level specified in step S5 and at the two next lower levels (it is assumed here that the totalization results or detail data at three levels are extracted and displayed as shown in FIGS. 8 to 11).

In step S7, the display control unit 5 displays the specified level at the leftmost end of the screen. As shown at (5) in FIG. 8, the totalization result at the specified level in the hierarchical structure displayed in the left window is displayed at the leftmost end of the right window.

In step S8, as instructed by the user, the display control unit 5 scrolls the initial display screen displayed in step S7, for example, the display screen shown in FIG. 8, until the desired totalization result or data appears on the screen according to an instruction from the user. The user refers to the displayed data.

In step S9, the user may enter data as required. The user enters data in the state where the desired totalization result or data is displayed in step s8. After data entry, a return is made to step S2 to update the detail data 1 and repeat the totalization of figures at each level based on the updated detail data 1.

Thus, the computing unit 3 computes the total of figures at each level in the structure 2 on the basis of the detail data 1 and the structure 2 for each user. The display control unit 5 displays the totalization results or data at the level specified on the structure 2 corresponding to the specified axis and at two next lower levels on the screen with the specified level at the leftmost end as shown in FIGS. 8 to 11. Thereby, it becomes possible to display the totalization results or data at the level specified on the axis specified in the hierarchy corresponding to the structure 2 for each user and at some lower levels intelligibly and quickly. In addition, the user is allowed to make data entry with the totalization results or data displayed.

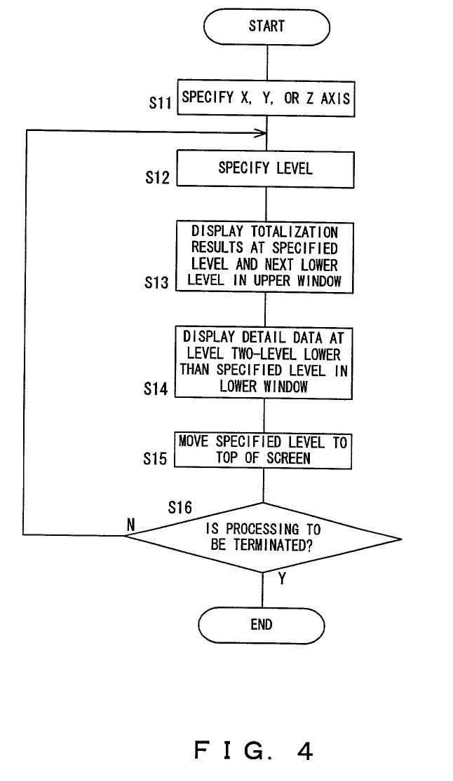

FIG. 4 is a flowchart for the operation of totalizing detail data and displaying the results.

In step S11, the user specifies the X, Y or Z axis in the structure 2. Specifically, the user selects one of X, Y and Z buttons in FIG. 8 which will be described later.

In step S12, the user specifies a display level in the hierarchy of the axis specified in step S11, for example, a level to be displayed on the structure for the X axis selected as shown at (1) in FIG. 8 (the structure 2 displayed in the left window) as shown at (5) in FIG. 8.

In step S13, the display control unit 5 displays the totalization results at the specified level and the totalization results at the next lower level in the window in the upper right portion of FIG. 8.

In step S14, the display control unit 5 displays the totalization results or detail data at the level which is two level lower than the specified level in the window in the lower right portion of FIG. 8.

In S15, the display control unit 5 moves the specified level to the top of the screen. For example, the display control unit 5 moves the totalization results or detail data at the level specified on the structure 2 displayed in the left window shown in FIG. 8 to the top left end in the upper/lower windows on the right-hand side of FIG. 8, thereby providing an easy-to-view display as shown at (5) in FIG. 8.

In step S16, a decision is made as to whether the processing is to be terminated or not according to an instruction given by the user. If YES, the processing comes to an end; otherwise, a return is made to step S12 to repeat the above processing.

Thus, when the user specifies a level on the structure 2 corresponding to the specified axis, the display control unit 5 displays the totalization results at the specified level and the next lower level in the upper right window of FIG. 8 and the totalization result/detail data at the level which is two level lower than the specified level in the lower right window, and then displays the totalization results at the specified level at the top left end of the window for easier viewing through scrolling. Thereby, the mere specifying of a level on the structure corresponding to the specified axis by user allows the totalization results/detail data at the specified level, at the next lower level and at the level which is two level lower than the specified level to be displayed intelligibly.

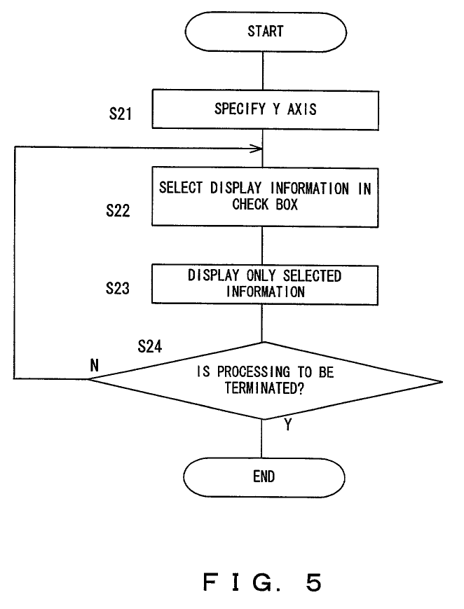

FIG. 5 is a flowchart for the process of displaying detail data when the user specifies a level.

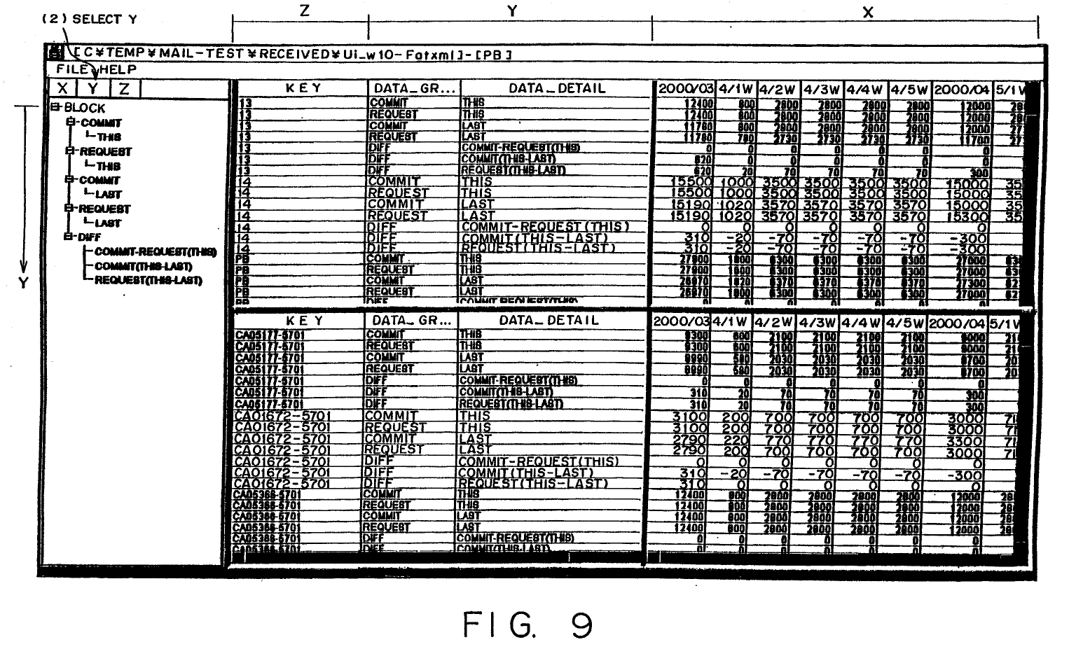

In step S21, the user specifies an axis of the structure 2. For example, the user selects (specifies) the Y axis as shown at (2) in FIG. 9. The display control unit 5 then causes the structure 2 corresponding to the Y axis to be displayed in the left window of FIG. 9.

In step S22, the user selects information to be displayed on the Y-axis structure 2 displayed in the left window of FIG. 9 through check BOX.

In step S23, the display control unit 5 displays only information at a level lower by one on the structure selected through the check BOX in step S22.

In step S24, a decision is made, as requested by the user, as to whether or not the processing is to be terminated. If YES, the processing comes to an end; otherwise, a return is made to step S22 to repeat the above processing.

Thus, when the user selects information he or she wants to display on the structure 2 through the check BOX, the display control unit 5 allows only the information at the level which is one level lower than the specified level to be displayed, thereby allowing the totalization results/detail data at the lower level to be displayed intelligibly in the upper and lower windows on the right-hand side of the screen.

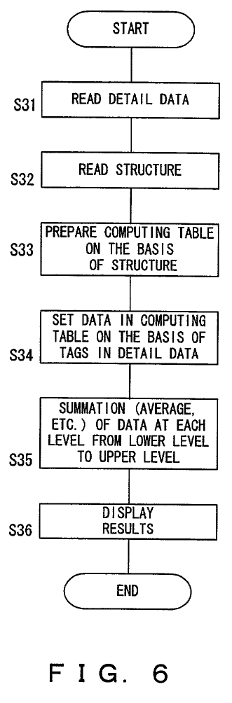

FIG. 6 is a flowchart for the procedure of totalizing data and displaying the results as instructed by the user.

Instep S31, the computing unit 3 reads in the detail data 1. In step S32, the computing unit 3 reads in the structure 2.

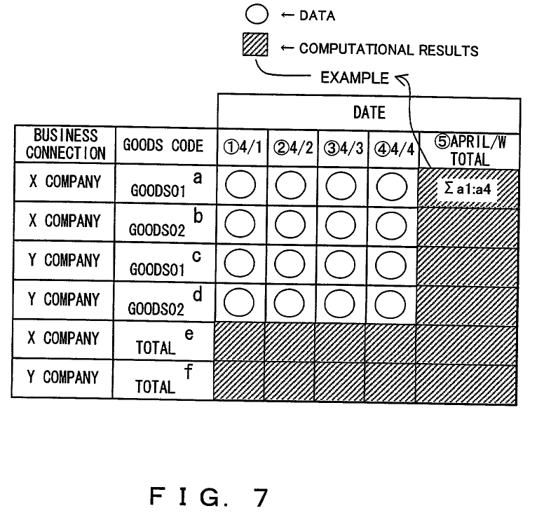

In step S33, the computing unit 3 prepares a computing table (a table for totalization processing, say, a table in Excel) of FIG. 7 to be described later on the basis of the structure 2 read in step S32.

In step S34, as shown in FIG. 7, the computing unit 3 sets data in the resulting computing table on the basis of tags in the detail data 1 (corresponding data is set in each cell marked with a circle).

In step S35, the computing unit 3 carries out totalization (or averaging etc.)on data which are set in cells marked with circles in FIG. 7, from a lower level to an upper level and sets the result of totalization in each of shaded cells.

In step S36, the display control unit 5 activates a display routine and, on the basis of the computing table of FIG. 7 in which the detail data and the totalization results have been set, displays the totalization results/detail data at the specified level and at the next lower level in the upper window on the right-hand side of FIGS. 8 to 11 and the totalization results/detail data at the level which is two level lower than the specified level in the lower window.

Thus, the computing unit 5 prepares a computing table on the basis of the detail data 1 and the structure 2, sets detail data in the computing table on the basis of tags in the detail data 1 and sets the totalization results/detail data in the computing table, allowing the totalization results/detail data at the level specified on the structure, at the next lower level and at the level which is two level lower than the specified level to be displayed on the screen in an intelligent manner.

FIG. 7 shows an example of a computing table, which is used for totalization processing at the time of placing orders. This table corresponding to a table, for example, in the Excel (registered trade mark). The computing unit 3 creates a table corresponding to the hierarchy in the structure 2, sets data in cells other than shaded cells on the basis of tags in the detail data 1, and sets the totalization result in each shaded cell.

FIGS. 8 to 11 show display examples in the present invention.

FIG. 8 shows a first display example. In this example, the structure 2 corresponding to the X axis is displayed in the left window since the user has selected X as shown at (1) in FIG. 8. On the structure 2, the level (4/2W: the second week of April) is specified as shown at (5). When the user specifies the level (4/2W), such upper and lower windows as shown in FIG. 8 are displayed in the right-hand portion of the screen.

In the upper window are displayed the totalization results at the level specified by a user on the structure 2 and the results at the next lower level. The totalization result is displayed with the selected level (4/2W) corresponding to the X axis on the structure 2 set in the leftmost end of the right window, using levels corresponding to the Z axis as a key, in correspondence with the information corresponding to the Y axis as shown in upper area in FIG. 8. In the lower window are displayed the totalization results at the level which is two level lower than the specified level.

FIG. 9 shows a second display example. In this example, the structure 2 corresponding to the Y axis is displayed in the left window since the user has selected Y as shown at (2) in FIG. 9. On the structure 2, the top level (BLOCK) is specified by the user. When the user specifies the top level (BLOCK), such upper and lower windows as shown in FIG. 9 are displayed in the right-hand portion of the screen.

In the upper window are displayed the totalization results at the level specified by user on the structure 2 and at the next lower level. The totalization result is displayed with information corresponding to the X axis on the structure 2 set in the leftmost end of the right window, using levels corresponding to the Z axis as a key, in correspondence with the selected level (BLOCK) corresponding to the Y axis as shown in upper area in FIG. 9. In the lower window are displayed the totalization results at the level which is two level lower than the specified level.

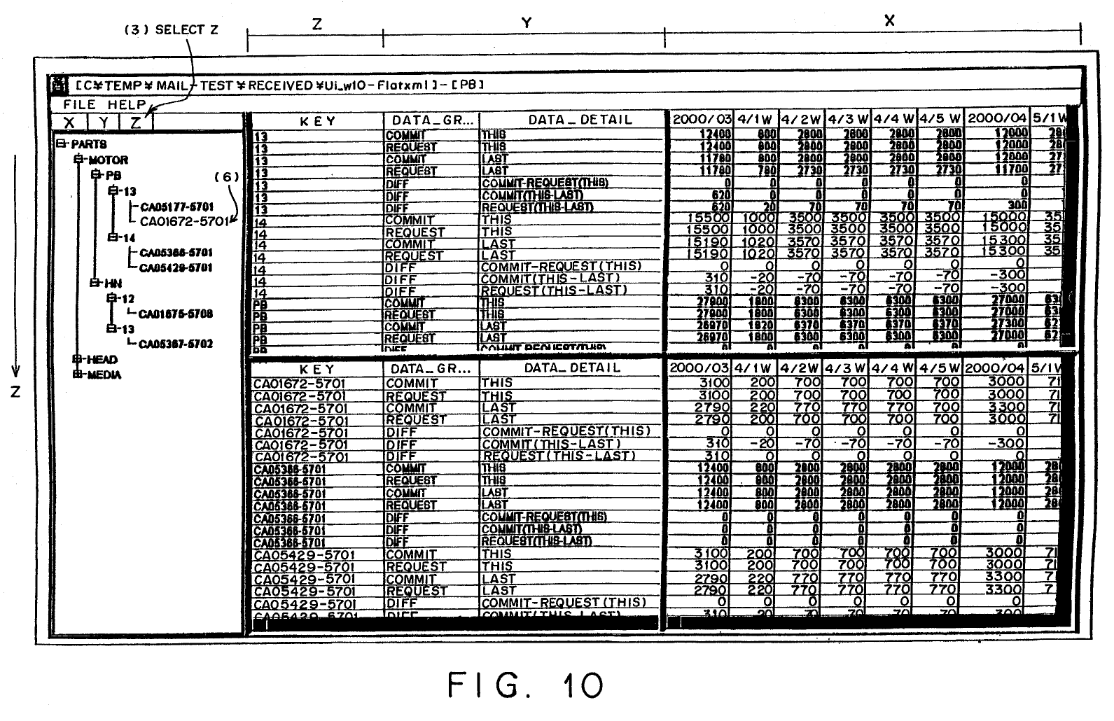

FIG. 10 shows a third display example. In this example, the structure 2 corresponding to the Z axis is displayed in the left window since the user has selected the Z axis as shown at (3) in FIG. 10. On the structure 2, the level (PB) and the point (CA1672-5701) shown at (6) is specified by the user. When the user specifies this level, such upper and lower windows as shown in FIG. 10 are displayed in the right-hand portion of the screen.

In the upper window are displayed the totalization results at the level specified by user on the structure 2 and the results at the next lower level. The totalization result is displayed with information corresponding to the X axis on the structure 2 set in the leftmost end of the right window, using selected level (PB) according to the Z axis as a key, in correspondence with the information corresponding to Y axis as shown in upper area in FIG. 10. In the lower window are displayed the totalization results at the level which is two level lower than the specified level.

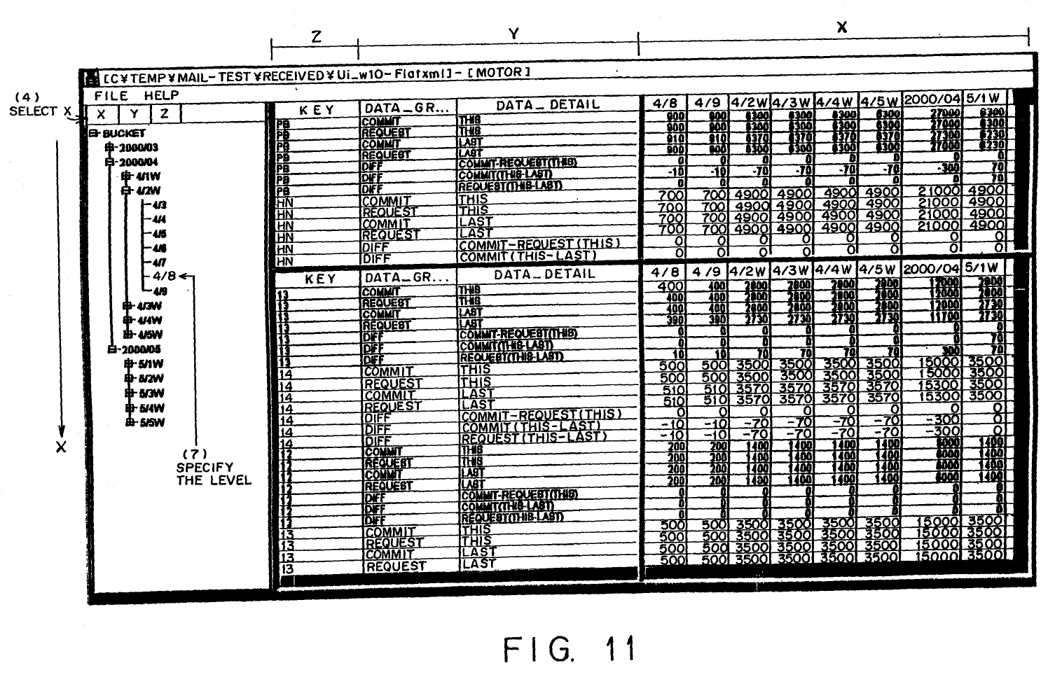

FIG. 11 shows a fourth display example. In this example, the structure 2 corresponding to the X axis is displayed in the left windows since the user has selected the X axis as shown at (4) in FIG. 11. On the structure 2, the level (4/8) shown at (7) is specified by the user. When the user specifies this level, such upper and lower windows as shown in FIG. 11 are displayed in the right-hand portion of the screen.

In the upper window are displayed the totalization results at the level specified by user on the structure 2 and at the next lower level. The totalization result is displayed with the selected level (4/8) corresponding to the X axis on the structure 2 set in the leftmost end of the right window, using levels according to the Z axis as a key, in correspondence with the information corresponding to Y axis as shown in upper area in FIG. 11. In the lower window are displayed the totalization results at the level which is two level lower than the specified level.

As described above using FIGS. 8 to 11, the display control unit 5 displays the structure in the left window of the screen according to the selection made by the user (X axis selection: (1) and (4), Y axis selection: (2), Z axis selection: (3)). When the user selects the level on the structure 2, the display control unit 5 displays the totalization results at the level specified by the user on the structure 2 and those at the next lower level than the specified level in the upper right window. And the display control unit 5 displays the totalization results at the level which is two levels lower than the specified level in the lower right window.

According to the present invention, as described above, the detail data 1 and the structures 2 representing totalization hierarchies and totalization results at a level specified on the structures, and those at the next lower level and, if necessary, at the level two-level lower than the specified level are displayed together, which eliminates the necessity of adding classification information to data divisions and allows the levels to be switched instantly, allowing required totalization information to be displayed. Thereby, totalization information can be displayed very readily in a form each individual user demands independently of data contents and regardless of the presence or absence of classification information for totalization.

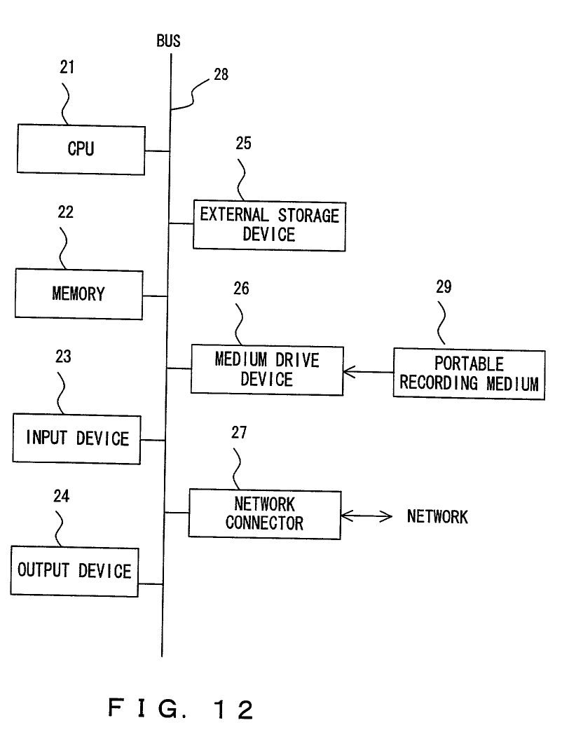

The system described previously may each comprise an information processing unit (computer) as shown in FIG. 12. The information processing unit 20 is composed of a CPU 21, a memory 22, an input device 23, an output device 24, an external storage device 25, a medium drive device 26, and a network connector 27, which are interconnected by a bus 28.

The memory 22 comprises a ROM (Read Only Memory), a RAM (Random Access Memory), etc., and store programs and data used for processing. The CPU 21 calls necessary programs from the memory into execution to perform required processing.

Pieces of parts that make up the system are each stored in a specific program code segment in the memory 22 as a program. The input device 23 is a keyboard, a pointing device, a touch panel, or the like and used to enter commands and information from a user. The output device 24 is a display, a printer, or the like and used to inquire of the user and output the results of processing.

The external storage device 25 is a magnetic disk drive, an optical disk drive, a magneto-optical disk drive, or the like. The above programs and data may be recorded on the external storage device 25 and loaded into the memory 22 when necessary.

The medium drive device 26 is adapted to drive a portable recording medium 29 and make access to recorded contents of it.

The portable recording medium 29 is a computer-readable recording medium, such as a memory card, a memory stick, a floppy disk, a CD-ROM (Compact Disk Read Only Memory), an optical disk, a magneto-optical disk, a DVD (Digital Versatile Disk), or the like. The above programs and data may be recorded on the portable recording medium 29 and loaded into the memory 22 when necessary.

The network connector 27 is adapted to communicate with external units over a network (line), such as a LAN, a WAN, or the like, and provide data conversion involved in communication. The network connector may be used to receive the above programs and data from an external unit and load them into the memory 22.

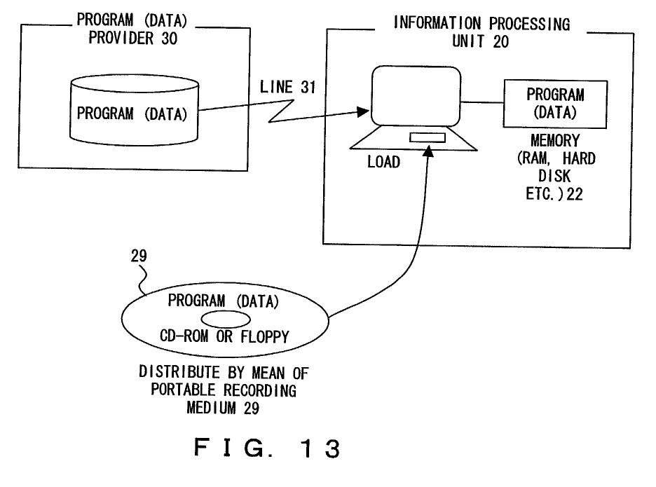

FIG. 13 shows a recording medium which can be read by the information processing unit 20 of FIG. 12, transmit signals, and transmission media.

The present invention may be practiced in the form of a recording medium 29 which can be read by an information processing unit and, when used with the unit, allows the unit to perform functions the same as those implemented by the units in the aforementioned embodiment.

Programs which allow the information processing unit to perform the same processing as that in the embodiment are stored on the computer-readable recording medium 29 . As shown in FIG. 13, the programs are read from the recording medium into the information processing unit and then stored in the memory 22 or the external storage device 25. The programs are called by the CPU 21 into execution.

The programs may be downloaded from a program (data) provider 30 into the information processing unit 20 over a line (transmission medium) 31. The functions implemented by the units described in the embodiment may be performed by a general-purpose computer.

While the invention has been described with reference to the preferred embodiments thereof, various modifications and changes may be made to those skilled in the art without departing from the true sprit and scope of the invention as defined by the claims thereof.

What is claimed is:

1. A totalization system for totalizing information to be totalized comprising:
a to-be-totalized information storage unit for storing information to be totalized;
a hierarchical information storage unit for storing hierarchical information used in totalizing the information to be totalized; and
a computing unit for totalizing the information stored in the to-be-totalized information storage unit according to the hierarchical information stored in the hierarchical information storage unit.

2. The totalization system according to claim 1, further comprising a display control unit for controlling display of totalization results for information at a arbitrary hierarchical level in the hierarchical information and, if necessary, information at a hierarchical level lower than the arbitrary level or totalization results for information at the lower hierarchical level.

3. The totalization system according to claim 2, wherein the display control unit controls display of information at an even lower hierarchical level or totalization results for information at the even lower hierarchical level.

4. The totalization system according to claim 1, wherein the to-be-totalized information are classified into a plurality of groups, the hierarchical information storage unit stores hierarchical information about the plurality of groups, and the computing unit totalizes information stored in the to-be-totalized information storage unit on the basis of hierarchical information about any one of the groups.

5. A computer-readable recording medium which is recorded with a program that allows a computer to perform a control operation for totalizing information, the control operation comprising the steps of:
storing information to be totalized;
storing hierarchical information used in totalizing the information to be totalized; and
totalizing the information to be totalized on the basis of the hierarchical information.
